(19) United States
(12) Patent Application Publication
(10) Pub. No.: US 2011/0210283 A1
(43) Pub. Date: Sep. 1, 2011

(54) Low melting temperature alloys with magnetic dispersions

(75) Inventors: Ainissa G. Ramirez, New Haven, CT (US); Eric L. Hayes, Washington, DC (US)

(73) Assignee: Ainissa G. Ramirez, New Haven, CT (US)

(21) Appl. No.: 13/033,380

(22) Filed: Feb. 23, 2011

Related U.S. Application Data
(60) Provisional application No. 61/307,590, filed on Feb. 24, 2010.

(51) Int. Cl. H01F 1/03; B82Y 25/00

(52) U.S. Cl. 252/62.55; 977/779

(57) ABSTRACT

A low melting temperature composite material including an alloy having about 0.1% by weight to about 99% by weight of tin and about 0.1% by weight to about 90% by weight of an element selected from the group consisting of silver and gold, and about 0.1% by weight to about 50% by weight of magnetic particles dispersed in the alloy. Method of heating such a composite material, remotely manipulating such a composite material with magnetic fields, enhancing the mechanical properties of such a material, and making such a material are also disclosed.

### CROSS-REFERENCE TO RELATED APPLICATIONS

This application claims the priority of U.S. Provisional Application No. 61/307,590 filed on Feb. 24, 2010, which is incorporated herein by reference herein in its entirety.

### STATEMENT REGARDING FEDERALLY SPONSORED RESEARCH OR DEVELOPMENT

This research was supported in part by U.S. Government funds (National Science Foundation Grant No. CMMI-0925994) and the U.S. Government therefore has certain rights in the invention.

### BACKGROUND OF THE INVENTION

Solder is a ubiquitous joining material for the construction of electronics devices, serving to interconnect electronic components by providing conductive pathways. Traditional solders are lead-based alloys, and most commonly a tin-lead solder alloy (Sn-37% Pb) having about 37% lead in a tin base material. However, environmental and human health concerns have prompted the search for replacements compositions. In addition, recent restrictions in both Japan and the European Union necessitate a switch to lead-free solder alloys. Currently, there is no drop-in replacement for Sn-37% Pb solder, and work is ongoing to improve both mechanical properties and wetting characteristics of lead-free solders. These characteristics are critical for solder joint and thus electronic device reliability, both in manufacturing and in service.

Unfortunately, the most suitable lead-free replacement, a tin-silver based alloy with the composition of Sn-3.5% Ag, has a melting point of 220° C., nearly 40° C. higher than the Sn-37% Pb alloy's melting point of 183° C. In addition, Sn-3.5% Ag alloys requires even higher processing temperatures, which are often 30 to 40° C. above the melting point. Similarly, another potential replacement, tin-silver-copper solders (for example Sn-3.5% Ag-0.74% Cu), have a melting point of about 217° C. Exposing electronic components to such elevated temperatures can adversely affect device performance.

In addition, the creation of conductive three-dimensional pathways for modern microelectronic devices relies on the stacking of two-dimensional photolithographically-placed layers or the creation of vertical vias perpendicularly between layers of electronic devices.

Available tin-silver alloys also exhibit reduced strength as compared with conventional tin-lead solders, which is detrimental to the long-term viability of joints created with tin-silver solder, since those joints may exhibit more creep and eventually loss of contact. Additionally, these solders underperform in drop tests, which can lead to joint failure and limits their performance when used in consumer electronics. A variety of approaches have been used to strengthen solder alloys, both leaded and lead-free, including the introduction of oxide particle or other dispersions to act as obstacles and impede dislocation movement. For example, oxide nanoparticles (Al₂O₃ and TiO₂), inter-metallic particles (Cu₆Sn₅), metallic particles (Cu, Ag, Ni), NiTi shape-memory alloys, and carbon nano-tubes have been tried as dispersions. Others have used nanodispersions of silver nanoparticles, Al₂O₃ nanoparticles, and nanostructured organic-inorganic hybrid polymers in an effort to modify mechanical properties of solder alloys. Also, small quantities of iron (2.5% by weight) have been plated with tin and added to Bi-43% Sn solder (which has a low 135° C. melting point) to improve creep resistance after cooling the solder in a magnetic field.

### SUMMARY

Low melting temperature composite materials for use as solders are formed by combining low melting point alloys with magnetic particles that are not alloyed and do not wholly dissolve. The materials can use various alloys including Sn—Ag and Sn—Ag—Cu based solders. In one embodiment, the composite materials include from about 2% to about 3.5% by weight of Ag, from about 0% to about 1% by weight of Cu, and from about 1% to about 10% by weight of metallic particles, with the balance being Sn. In another embodiment, the composite materials contain about 5% to about 10% by weight of magnetic dispersions such as Fe, Fe₃O₄, Ni, or Co, sized from about 1 micron to about 50 microns.

There is a trade-off in determining a preferred concentration of magnetic particles, depending on the intended use of the composite materials. By increasing the percentage of particles, the strength and induction heating susceptibility of the materials increase, but the elongation and ductility decrease while the viscosity increases. These factors provide an indication of the toughness and flowability of the materials when they are molten. Therefore, for many (but not all) applications, a concentration of about 5% to about 10% magnetic dispersions is likely to combine the benefits of increased strength without significant loss in ductility.

A low melting temperature composite material is disclosed including an alloy of about 0.1% by weight to about 99% by weight of tin with about 0.1% by weight to about 90% by weight of an element selected from the group consisting of silver and gold, combined with about 0.1% by weight to about 50% by weight of magnetic particles dispersed in the alloy.

In one embodiment, the composite material has about 75% by weight to about 97% by weight of tin, about 1% by weight to about 5% by weight of silver, and about 0.5% by weight to about 20% by weight of magnetic particles. In another embodiment, the composite material has about 84.5% by weight to about 97% by weight of tin, about 2% by weight to about 3.5% by weight of silver, and about 1% by weight to about 10% by weight of magnetic particles. In yet another embodiment, the composite material further includes about 0.1% by weight to about 5% by weight of copper.

The magnetic particles preferably include one or more of ferromagnetic, ferromagnetic, and paramagnetic materials. In one embodiment, the magnetic particles include ferromagnetic oxides selected from the group consisting of Fe₃O₄, MNFe₂O₄, NiFe₂O₄, MgFe₂O₄, Fe₇S₈, Fe₃S₄, g-FeOOH, Yttrium iron garnet (YIG), and any combination of these materials and their alloys. In another embodiment, the magnetic particles include ferromagnetic materials selected from the group consisting of Co, Fe, Ni, Gd, Dy, EuO, Fe₃O₄, NiOFe₂O_{3′} MgOFe₂O₃, MnBi, MnO, Fe₂O₃, Y₃Fe₅O₁₂, CrO₂, MnAs, MnB, Mn₄N, MnSb, CrTe, CoO, NiO, CuO, BaCO₃, SrCO₃, MnZn, SmCo, AlNiCo, MnO, FeO, UH₃, Heusler Alloys (Cu₂MnAl, Cu₂MnIn), NdFeB, Permalloy (nickel-iron alloys), Supermalloys (79% Ni, 5% Mn, 16% Fe), magnetic stainless steel alloys (304 and 316), and any combination of these materials and their alloys. In yet another embodiment, the magnetic particles include paramagnetic materials selected from the group consisting of Na, Al, salts of transition metals, salts and oxides of rare earth, rare earth elements, many metals, and any combination of these materials and their alloys. In still another embodiment, the magnetic particles include one or more of elemental metal, mixtures of elemental metals, oxides, nitrides, carbides, borides and fluorides, iron, cobalt, nickel, and any combination of these materials and their alloys.

To improve the strength of the composite material, the magnetic particles can be clustered into particle-rich and particle-depleted zones by application of a unidirectional magnetic field. The magnetic particles can be one or more of spherical, elongated, plate-like, rod-like, nanowires, or randomly shaped. The magnetic particles can also be one or more of particles, intermetallics, separate phases, solute atoms, nanoparticles, and precipitates.

The magnetic particles can have a size from about 1 nm to about 500 microns. In one embodiment, the magnetic particles have a size from about 100 nm to about 100 microns. In another embodiment, the magnetic particles have a size from about 1 micron to about 50 microns.

A method is disclosed for heating a low melting temperature composite material comprising an alloy of about 75% by weight to about 97% by weight of tin and about 1% by weight to about 5% by weight of silver, and about 0.5% by weight to about 20% by weight of magnetic particles. The method includes exposing the composite material to induction heating conditions generated by an alternating magnetic field. The magnetic field can be alternated at a frequency of about 5 kHz to about 50 kHz.

A method is disclosed for manipulating a low melting temperature composite material comprising an alloy of about 75% by weight to about 97% by weight of tin and about 1% by weight to about 5% by weight of silver, and about 0.5% by weight to about 20% by weight of magnetic particles. The method includes heating the composite material to a melting temperature and applying a magnetic field to attract or repel the molten composite material. The heating can be accomplished by exposing the composite material to an alternating magnetic field. In one embodiment, the method further includes causing the molten composite material to move in a vertical upward direction by applying an attractive magnetic force above the composite material. In another embodiment, the method further includes causing the molten composite material to act as a conveyance for a lower density object located on top of the composite material by applying an attractive or repulsive magnetic force laterally with respect to the composite material.

A method is disclosed for enhancing the mechanical properties of a low melting temperature composite material comprising an alloy of about 75% by weight to about 97% by weight of tin and about 1% by weight to about 5% by weight of silver, and about 0.5% by weight to about 20% by weight of magnetic particles. The method includes applying a unidirectional magnetic field to alloy while the alloy is cooled from a molten state to a solid state.

A method is disclosed for making a low melting temperature composite material, including grinding together a mixture of iron powder with Sn—Ag solder powder, adding flux to the powder mixture to form a paste, and heating the paste to boil off the flux and melt the paste.

### BRIEF DESCRIPTION OF THE FIGURES

FIG. 1 illustrates exemplary magnetic dispersions suspended in a molten Sn—Ag solder matrix in various arrangements: FIG. 1a is a schematic showing magnetic dispersions randomly distributed in a solder matrix; FIG. 1b is a scanning electron micrographs (SEM) showing magnetic particles (dark gray spots) homogenously incorporated in an Sn—Ag solder matrix (light gray region); FIG. 1c is a schematic showing that when exposed to a suitable magnetic field, the magnetic particles cluster along the flux lines to form columns within the solder matrix; FIG. 1d is an SEM micrograph showing alignment throughout the thickness of the alloy (white arrows indicate columns).

FIG. 2 is a series of photographs showing vertical movement of a magnetically-responsive low-melting point solder alloy as a result of application of a 1,000 G ceramic magnet above the melted solder; the sequence of images taken over a 1-second time period shows the solder rising up towards the magnet.

FIG. 3 is a set of photographs showing an array of structures made with magnetically-responsive solder alloys: FIG. 3a is an SEM micrograph of silicon vias that have been filled with magnetically-responsive alloy; FIG. 3b is a magnified SEM micrograph of one of the silicon vias of FIG. 3a; FIG. 3c is a photograph showing a three-dimensional structure rapidly generated with a magnetically-responsive alloy in a PDMS mold by drawing molten solder alloy vertically upward from a reservoir into a Y-shaped cavity within PDMS using samarium cobalt magnets; FIG. 3d is a photograph of the extracted Y-shape after solidification of the alloy; FIG. 3e is a photograph showing the formation of a magnetically-responsive solder alloy into a “spikey” morphology often associated with ferrofluids, indicating the application of magnetic force to such alloys can overcome the sum of the surface and gravitational forces.

FIG. 4 graphically illustrates mechanical behavior at room temperature of dispersion-containing alloy tensile samples: FIG. 4a shows stress-strain curves for Sn—Ag alloy with increasing amounts of iron dispersions; FIG. 4b shows the impact of aligned particles in stress-strain curves for samples of Sn—Ag alloy including 5% Fe by weight that were cast within a magnetic field (aligned orientation) and without a magnetic field (random orientation), as compared with a sample of Sn—Ag alloy without dispersions. The inset in FIG. 4b is a schematic of a composite sample with “a” hard layers (particle-rich regions) on either side of a “b” soft layer (particle-depleted regions).

FIG. 5a illustrates an experimental setup to test the magnetic induction heating response of solder with and without magnetic dispersions; the setup shows a magnetic induction heating experiment on two samples of low melting temperature alloy (one with and one without dispersions) under the same induction conditions; FIGS. 5b and 5c shown the magnetic induction heating responses of tested alloys with (b) dispersions of different magnetic elements and (c) iron dispersions at different concentrations.

FIGS. 6a, 6b, and 6c are graphs showing the effect on tensile strength of adding 10% and 20% 325 mesh Fe by weight to Sn—Ag solder at different strain rates.

FIG. 7 is a graph showing the effect on tensile strength of 1-3 micron Fe particles in Sn—Ag solder at 2.5% and 5% Fe by weight.

FIG. 8 is a graph showing elastic modulus, ultimate tensile strength, and ductility of exemplary Sn—Ag solder alloys with Fe dispersions at a 0.0002/s strain rate.

FIG. 9 is a graph showing ultimate tensile strength versus strain rate of exemplary Sn—Ag solder alloys with Fe dispersions.

FIG. 10 is a graph showing the effect on tensile strength of reflowing an Sn—Ag solder alloy with Fe dispersions in a magnetic field.

FIG. 11 is a bar graph showing a comparison of the surface temperature of various composite and conventional solders when subjected to induction heating.

FIG. 12 is a schematic of showing a three-panel sequence of a self-healing composite magnetic solder material, wherein a solder joint exists, fails, and is healed in the presence of a magnetic field.

FIG. 13 is a schematic drawing showing a two-panel sequence of a magnetic fuse, wherein a composite magnetic solder material forms a connection between two conductors that is broken under application of a magnetic field.

FIG. 14 is a schematic drawing illustrating horizontal conveyance of an object having a lower density than a composite magnetic solder material by application of a magnetic field.

### DETAILED DESCRIPTION

Composite materials are disclosed which include magnetic particles suspended as dispersions in low melting temperature metallic alloys such as lead-free solders. The composite lead-free solder materials have tailorable mechanical properties, the ability to be guided in three-dimensions with a magnetic field, and the ability to be heated rapidly by electromagnetic induction.

Magnetic particles may be any shape: spherical, elongated, plate-like, rod-like, nanowires, or randomly shaped. The form of the “particles” can be particles, intermetallics, separate phases, solute atoms, nanoparticles and precipitates. Typical size ranges from nanometers to 500 microns, with a preferred range of 100 nm to 100 microns. Volume fraction of the magnetic dispersoid can be from about 0.1% to about 50% with a preferred range of about 0.5 to about 20%. The form of the magnetic particles can be crystalline, amorphous, semicrystalline and nanocrystalline.

To improve the wetting of magnetic particles with solder, the particles may be coated with a thin layer of a suitable material, preferably a thin layer that is easily wettable by the solder matrix. For example, particles may be coated with tin, silver, copper, nickel, or iron which may be deposited by chemical vapor deposition, physical vapor deposition, electroless plating, electroplating, dilution of salts, critical point drying and liquid phase epitaxy. Another means to improve the bonding between the solder matrix and the magnetic particle is by adding reactive agents into the solder. A solder may contain a reactive agent, such as indium, titanium, or a rare-earth metals (i.e., the lanthanide series of the periodic table which includes but is not limited to cerium, lutetium, and erbium), which will bond with the magnetic particles and an oxide film often on the surface magnetic particles. Such reactive solder are commercially available and can be readily synthesized, as for example in U.S. Pat. Nos. 6,319,617 and 6,306,516.

Magnetic particles should retain their magnetic properties at the operating temperatures of the solder, particularly at the solder's melting points, so the magnetic particles can respond to a magnetic field even when the solder is molten. This enables the movement of solder when a suitable magnetic field is applied. Accordingly, the Curie temperature of the magnetic particles should be higher than the alloy melting points, which are typically in the range of 100° C. to 300° C. More generally, the metal matrix is a low melting point alloy (below 500° C.) of tin, silver, copper, indium, lead, and/or gold.

The benefits of incorporating magnetic particles into lead-free solder alloys include improved mechanical strength in comparison to conventional lead-free-solders, the ability to remotely manipulate molten alloys, and the ability to inductively heat (and melt) the alloys. The magnetic particles impede mechanical deformation in the solder, and improve mechanical strength and hardness of the disclosed solder alloys as compared with conventional lead-free solders.

Because the magnetic dispersions allow the solder alloys, when molten, to be responsive to magnetic fields, the solder alloys can be moved and manipulated remotely in both the horizontal and vertical directions by application of a magnetic field, for example to fill small geometries such as vertical paths (or vias), or to reaching hard-to-reach areas. Such solder alloys also enable the creation of small-scaled metallic structures with a reduced number of fabrication steps and can be the basis for self-healing assemblies and devices.

Composite materials containing lead-free solder alloys are disclosed that are magnetically-responsive and susceptible to induction heating, and have improved mechanical properties as compared to currently available lead-free solder alloys. In particular, tin-silver (Sn—Ag) alloys are disclosed having dispersions of magnetic particles that directly enhance the mechanical properties of the alloy, including alloy strength, while allowing localized heating using magnetic induction.

The magnetic particles enable the alloys to be heated to melting by magnetic induction heating in which the composite materials are exposed to an alternating magnetic field. The magnetic dispersions act as susceptors, heating the surrounding solder alloy to temperatures significantly higher than solder alloys without magnetic dispersions that are subjected to the same magnetic field, while allowing the substrate and components adjacent to the composite material to remain relatively cool. Localizing the heat required to melt solder alloys is particularly desirable for mounting and packaging of temperature-sensitive electronic devices such as those commonly found in optoelectronics. By minimizing the temperature excursions of printed wire boards and components, the integrity, reliability, and functionality of these components is significant improved.

Additionally, the composite materials display enhanced mechanical strength as compared with alloys not containing magnetic dispersions, which enables strong, durable, and creep resistant interconnects.

While it is contemplated that many low melting point alloys, including but not limited to bismuth- and indium-based alloys, can be altered by these methods, the following discussion is directed primarily to tin-silver based alloys as a representative alloy that has received recent attention by the electronics industry as lead-free solders.

Formation of composite materials including low melting temperature alloys with magnetic dispersions.

An exemplary embodiment of a composite material including tin-silver solder alloy containing magnetic particle dispersions is created by grinding together a mixture of iron powder with Sn—Ag solder powder using a mortal and pestle. Grinding is believed to help create new oxide-free surfaces on the iron particles, while also uniformly distributing the iron dispersoid powder in the solder. A zinc chloride and ammonium chloride flux designed for bonding to iron (such as Johnson Soldering Fluid) is added to the powder mixture to form a paste. The paste is heated in a graphite crucible preheated to 450° C. Within several minutes of heating, the flux is boiled off, leaving a small composite solder bead, which is quenched in water and washed to remove any flux residue. Using this method, substantially uniform distribution and wetting of the iron particles in the tin-silver solder matrix is obtained without the need to first plate the iron particles with tin, as had been previously required.

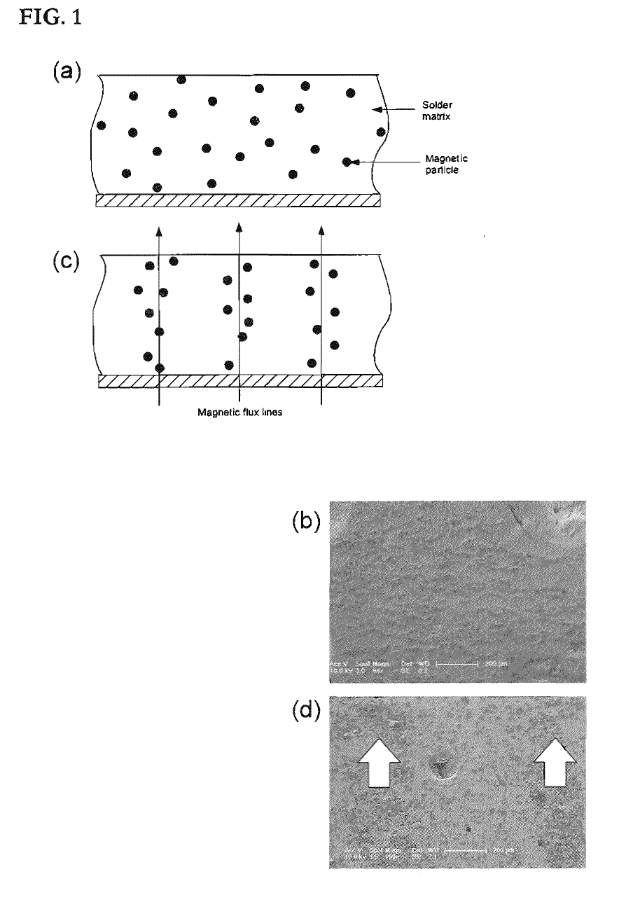

The mechanical strength of the composite material can be enhanced by creating alignment of the dispersions within the solder matrix. A magnetic field is applied to the composite material as it cools to below the alloy melting temperature, i.e., as the alloy is cooling and solidifying, such that the alignment will be set once the alloy is solidified. Without applying a magnetic field, the particles are randomly arranged within the solder, as in FIGS. 1a and 1b. However, when the solder is cast within a magnetic field, the particles become more ordered and arrange themselves in an aligned patterned, as in FIGS. 1c and 1d. Magnetic particles align in a direction of the field, which can be applied by AC, DC or a fixed magnet. Alignment of the particles occurs when a magnetic field is applied to the magnetic-particle containing solder that is molten. The solder matrix is heated by thermal, laser or electromagnetic induction means. In one embodiment, the magnetic field is unidirectional. In one set of testing, two magnets were used during solder solidification, one above a mold containing the alloy and the other below the mold, as a specimen cooled in the mold. An aligned dispersion configuration is shown schematically in FIG. 1c, and an SEM photograph of a composite material with aligned dispersions is shown in FIG. 1d.

Several magnetically responsive composite materials were prepared by incorporating magnetic dispersions into low melting point tin-silver alloys (of the composition of Sn-3.5% Ag), it being understood that other low melting point metal alloys could equivalently be used Mixtures were tested having about 1% to about 25% by weight of iron spheres at 325 mesh (<44 microns) thoroughly mixed into Sn-3.5% Ag powder. After crushing and mixing, the iron particles were randomly oriented. To improve incorporation of the particles and the adhesion of the solder, ammonium chloride was added to the dry mixture as a cleaning agent (or flux) to remove the oxide on the iron particles. Batches were prepared at various Fe concentrations using a master highly concentrated batch that was later diluted to reach desired dispersion concentrations. Upon heating of the mixture, the iron particles do not dissolve into the matrix, since iron has limited solubility in both tin and silver. Also, heating has a negligible effect on the magnetic properties of iron at the melting point of Sn-3.5% Ag (220° C.) due to iron's Curie temperature of 770° C.

A homogeneous distribution of magnetic particles in a low melting temperature alloy can be achieved by these methods, as shown schematically in FIG. 1a and under a scanning electron microscope (SEM) in FIG. 1b. Dark gray spots (iron particles) are embedded in a light gray matrix of tin-silver. It is possible to align the iron dispersions within the metallic alloy using a unidirectional magnetic field, as shown schematically in FIG. 1c. The aligned iron particles move into a stable configuration that minimizes the magnetostatic energy, in which columns of spheres are magnetized in the same direction and the magnetic pole interactions between the chain of spheres cause them to repel each other until an equilibrium spacing is reached. FIG. 1d shows an SEM micrograph of columns of these aligned iron dispersions in a tin-silver solder that was subjected to a unidirectional magnetic field of 2500 Gauss. The dark band of gray spots (iron particles) has a higher concentration along the field lines, indicated by the arrows.

Manipulation Via Magnetic Fields to Form Three-Dimensional Geometries.

Three-dimensional microelectronic fabrication requires an electrically conductive material that enables complex geometries that include both vertical and horizontal pathways. In one method of creating three-dimensional structures, a molten reservoir of magnetic composite solder material is used. The composite material can be heated by various methods, which include thermal heating, induction heating, or laser heating. An empty cavity or mold, which outlines the structure is placed in close proximity to the molten reservoir to serve as a scaffold to frame the final solder shape. A magnetic field is applied near the mold to direct and assist the movement of the solder. A magnetic material or an electromagnet can create the magnetic field. Once the cavity is filled, the workpiece is removed from the heat source and allowed to cool below the melting point of the composite solder material. When the mold has cooled, it can be removed to uncover the solder material shaped in the form of the former cavity. The shape can include vertical parts as well as horizontal and angled regions.

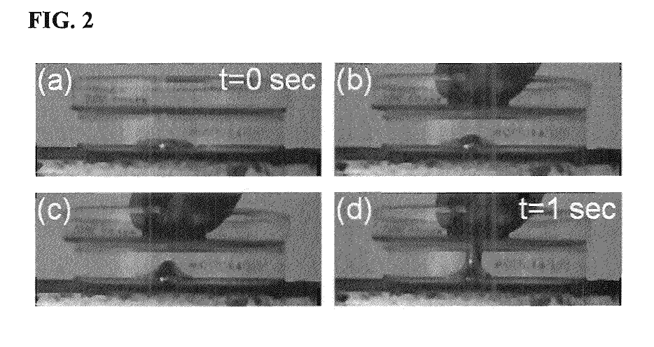

As disclosed, a composite material of low melting point metal alloy containing magnetic dispersions can be remotely manipulated by magnetic fields to create vertical geometries and thus enable novel three-dimensional assemblies. FIG. 2 shows an example of remote vertical manipulation of a molten composite alloy including a composite of Sn-37% Ag alloy with iron particles. Within one second of exposure to a ceramic magnetic hovering about 1 cm above a molten reservoir of the composite alloy material, the molten alloy material rose up toward a magnet, and by moving the magnet side to side, the vertical column of molten solder alloy could be shifted laterally.

Several exemplary structures were constructed using the magnetically responsive composite materials, including conductive pathways such as through silicon vias (TSV). Through silicon vias serve many functions, one of which is a conductive path between electrical elements on the top and bottom surfaces of silicon. Typically, these holes are coated with electroplated copper and filled with solder alloys. Coating the sides of the holes with copper assists the wicking process of the solder and provides conductive pathways.

The composite materials disclosed herein provide a way to fill these vias without the need for copper plating. With the simple application of a magnetic field, solder joints can be made directly. Additionally, the composite materials enable horizontal joints, and are not limited to vertical geometries as are current technologies for vias.

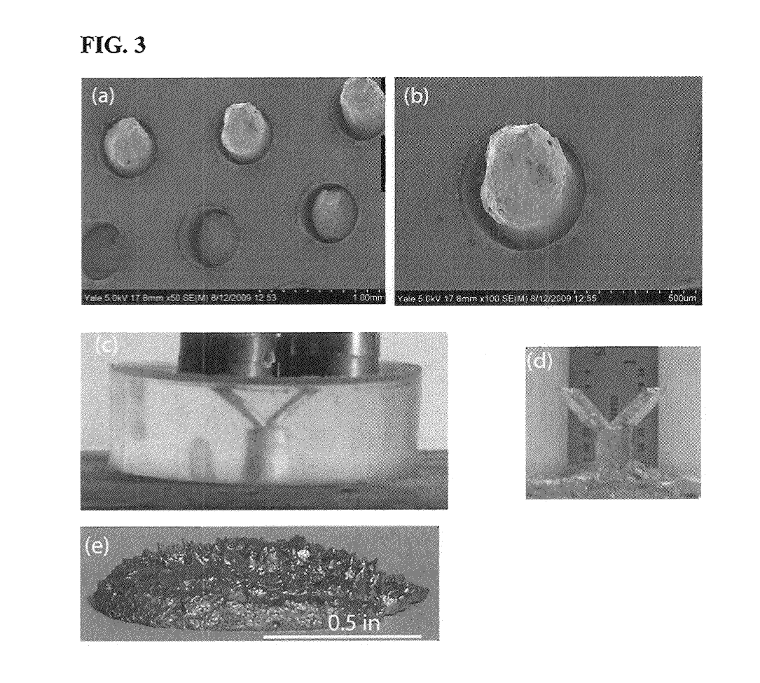

As shown in FIGS. 3a and 3b, a 2500 G magnet was used to draw molten solder alloy directly through holes (vias) 500 μm in diameter extending through a 400 μm-thick silicon wafer. The vias were made by deep reactive ion etching and were not coated with copper. Molten alloy was similarly drawn into the channels of a polydimethylsiloxane (PDMS) mold. The channels are as narrow as 700 μm in diameter and up to 4 mm deep. The resulting shapes were released once the molds reached room temperature. FIG. 3c shows the creation of a “Y” using this method and the extracted shape shown in FIG. 3d indicates lateral movement over the alloy.

As shown in FIG. 3e, when the composite material is unconfined and a higher magnetic field (3,000 G) is applied, the magnetic force on the dispersions is able to overcome the surface tension of the molten alloy and move the alloy upward following the magnetic flux lines to create the “porcupine” shape that is often associated with ferrofluids. This phenomenon allows the generation of sharp tips and, unlike ferrofluids, this shape can be maintained by solidification at room temperature and is thus a method for creating novel electronic devices.

Magnetic manipulation of the molten alloys is expected to find particular use in soldering between circuit devices with pad height irregularities, a process prone to inconsistency. Furthermore, magnetic manipulation could improve and simplify processes where molten solder alloy must be drawn along a channel, whether than channel is vertical, horizontal, or angled.

Induction Heating.

Iron dispersions act within a solder alloy matrix as susceptors for magnetic induction heating, allowing the rapid melting of the alloy at temperatures lower than those usually reported for conventional metal alloys. In addition, induction heating is concentrated in the alloy that contains the iron dispersions, so that high temperatures are localizing away from electronic boards and chips, minimizing temperature excursions and potential damage of those components. Induction heating can be accomplished by applying an alternating magnetic field to the composite material, which causes eddy current and hysteresis losses, particularly in the magnetic particles dispersed throughout the alloy. The resultant rapid melting of the alloy can occur at lower temperatures than those usually reported for conventional solders. Thus, induction heating can reduce the temperatures used in microelectronic fabrication and the sealing of its packages, thereby reducing warpage due to differences in thermal expansion.

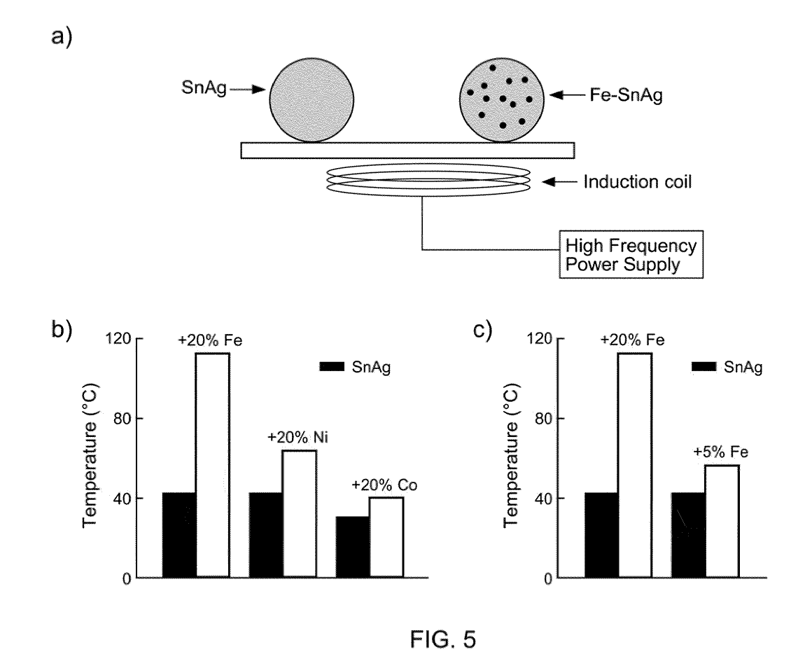

FIG. 5a is a schematic of an induction heating set up, where both dispersion-free and magnetic dispersion-containing samples of an Sn-37% Ag alloy were tested side by side under the same heating conditions. The heating rate depends on the type and amount of magnetic particles used (see FIG. 5b), as well as the induction frequencies, which can range from about 5 kHz to about 50 kHz. The lower frequencies of about 5 kHz to about 10 kHz may couple better to the magnetic particles and can heat more efficiently than higher frequencies. Nevertheless, any frequency approximately in the range of 5 kHz to 50 kHz will exhibit faster heating of magnetically-responsive solder than solders that do not contain magnetic particles.

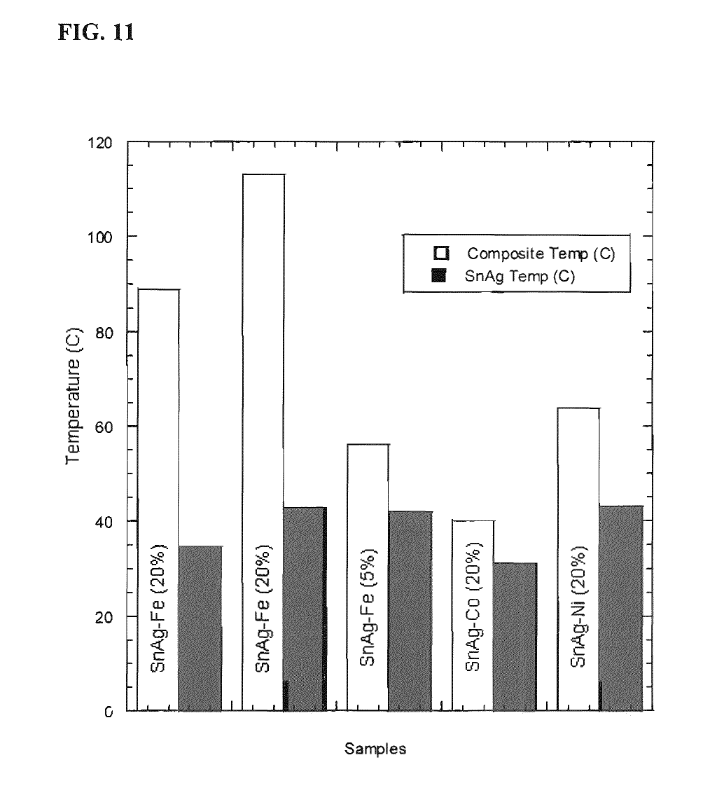

Six-gram samples were subject to a magnetic field of 8 kW at 350 V alternating at 12,150 Hz for one minute, and the surface temperature of the samples was measured with an infrared camera. The alloys containing iron dispersions recorded a surface temperature of about 118° C., while the alloys without dispersions were heated to only about 48° C. at the surface. Importantly, although these are surface measurements, it was readily apparent that the dispersion-containing solder was even hotter internally than measured on the surface, since it was easily deformed when pressure was applied. FIG. 11 shows a comparison of surface temperatures for several solder alloys with and without magnetic dispersions.

The impact of hysteresis heating was found significant with iron as well as with other particle dispersions. For example, as shown in FIG. 5b, nickel particle dispersions can also produce significant heating, while cobalt is somewhat less effective for these induction heating conditions. As shown in FIG. 5c, higher concentrations of magnetic Fe particles produced faster heating and/or heating to higher temperatures. However, compositions of solder alloys that may be selected for use in microelectronics must take into consideration heating efficiency as well as viscosity, which increases with dispersion concentration. Ongoing work is focused on improved heating rates by using low-frequency induction heating, including low frequencies less than 5 kHz, that directly couples with the magnetic particles.

Enhanced Mechanical Properties.

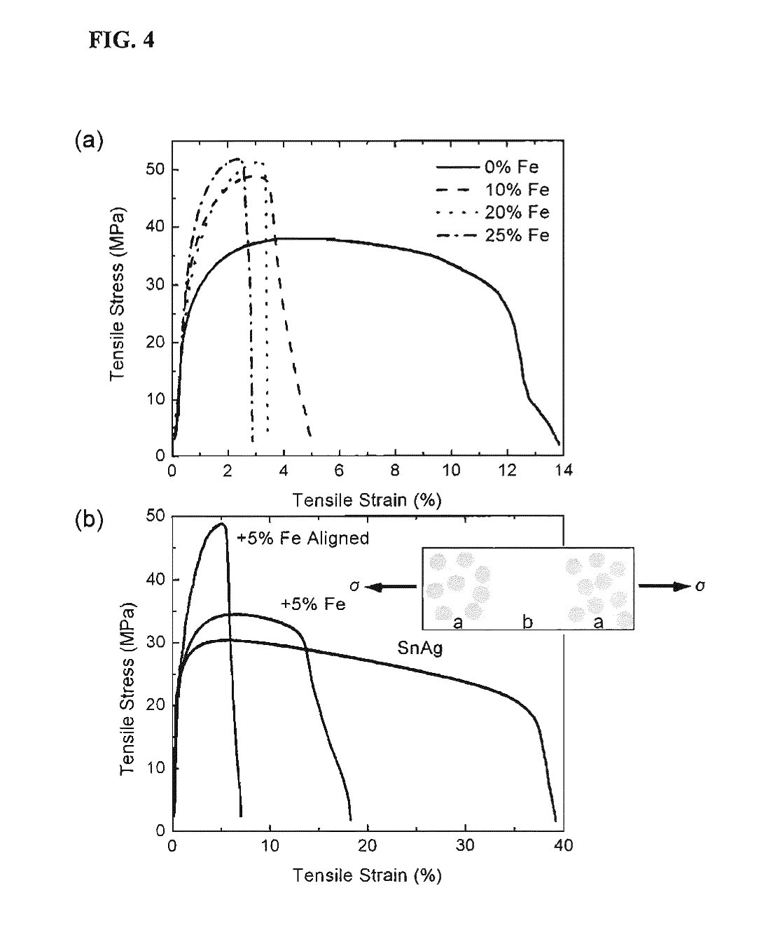

Iron dispersions in tin-silver alloys enhance the mechanical properties of the composite material. Mechanical stability is needed for strong, reliable interconnects, and in the disclosed composite materials, does not come at the expense of significantly altering the electrical properties of the alloys. Samples of various dispersion concentrations were tested under tension at a strain rate of 0.0002/s. The samples were heated to 250° C. for 5 minutes and cast in a heated aluminum mold to produce American Standard of Testing and Measurement (ASTM) standard dog-bone specimens (32 mm×6 mm). Tensile tests were performed at 25° C. FIG. 4a shows that the incorporation of dispersions dramatically increases mechanical strength, such that the ultimate tensile strength is improved by nearly 40% over the dispersion-free samples. However, ductility decreased, possibly because the dispersions provide more sites for void formation, coalescence, and fracture. The elastic modulus increased monotonically with increasing amounts of dispersions.

Table 1 (below) summarizes the average tensile properties of samples at different iron concentrations and shows that strength increases with dispersion concentration. The mechanical properties of the composite materials can be precisely controlled by the amount and the orientation of the magnetic particles within the metal alloy matrix.

TABLE 1
Mechanical, electrical and wetting properties of magnetically-
responsive composite materials including Sn—Ag alloys.

| Composition | | | | | | |
|---|---|---|---|---|---|---|
| (Sn—Ag + | Modulus | UTS | Elongation | Conductivity | Hardness | Contact |
| wt. % Fe) | (MPa) | (MPa) | (%) | (MΩ⁻¹/m) | (HV) | angle (°) |
| 0% Fe | 5158 | 34.5 ± 2.2 | 25.7 ± 7.4 | 944 ± 0.02 | 15.74 ± 0.47 | 12.1 ± 1.7 |
| (SnAg) | | | | | | |
| 5% | 4992 | 36.8 ± 1.6 | 15.0 ± 1.6 | — | 16.86 ± 0.54 | 11.3 ± 0.9 |
| 5% aligned | — | 48.7 ± 1.2 | 7.7 ± 2.1 | — | — | — |
| 10% | 7977 | 44.8 ± 3.4 | 5.5 ± 1.0 | 8.32 ± 0.10 | 16.34 ± 0.66 | 11.7 ± 1.7 |
| 10% aligned | — | — | — | 7.23 ± 0.16 | — | — |
| 20% | 9564 | 50.9 ± 0.6 | 4.7 ± 1.4 | 6.43 ± 0.18 | 27.15 ± 0.76 | 23.4 ± 1.5 |
| SnPb | — | — | — | 5.58 | 13.1 | 16 |
| (literature) | | | | | | |

The strength of the composite material can be further enhanced by the alignment of the dispersions, as shown in FIGS. 1c and 1d. FIG. 4b shows stress-strain curves of alloys with the same composition cast with and without a magnetic field and includes a dispersion-free sample for comparison. A sample of having 5% iron by weight, when cast within a magnetic field, shows a 20% increase in strength. In these aligned-dispersion arrangements, the solder material acts as a composite consisting of hard layers (particle-rich regions) and soft layers (particle-depleted regions), as illustrated in FIG. 4b. Plastic deformation in the soft layer is delayed by neighboring harder layers.

Despite the significant changes in mechanical properties by the addition of particle dispersions, the electrical resistivity and melting point of the composite alloys do not vary significantly from those of tin-silver. Resistivity of vertical connections was measured to be within the range of about 5 MΩ⁻¹/m to about 10 MΩ⁻¹/m, which is nominally the range for dispersion-free alloys formed into similar geometries. Therefore, the presence of particle dispersions does not negatively impact resistivity. In addition, as expected due to the lack of chemical activity between the dispersions and the base alloy, the melting point of the composite materials remains at about 220° C., essentially unchanged from the dispersion-free alloys.

Further, the wetting behavior of the composite material is substantially the same as a dispersion-free alloy. The contact angle was measured using beads of approximately 0.05 g of molten alloy on a copper substrate, and was about the same for dispersion-free alloy and composite materials up to about 10% by weight of Fe, as shown in Table 1. At greater dispersion concentrations in the composite material, the wetting angle increased monotonically.

The hardness of the composite material was also insensitive to the addition of dispersions of up to about 10% by weight Fe. Using a microindentor (measuring on the Vickers hardness scale) with a load of 100 g, it was found that the hardness of Sn—Ag alloy with about 10% Fe particle dispersions was 16.34±0.66 HV, which was nearly equivalent that of Sn—Ag alloy without dispersions, which was measured at 15.74±0.47 HV. But at about 20% by weight Fe the hardness nearly doubles to 27.15±0.76 HV.

In one embodiment, iron particles added to Sn—Ag solder significantly increase the ultimate tensile strength, while also enabling the molten solder alloy to be magnetically manipulated. Although many other ferromagnetic, paramagnetic, and ferromagnetic magnetic particles may alternatively be used, iron was exhibits strong ferromagnetism and high Curie temperature of 770° C., so that the ferromagnetism remains robust at well above the solder alloy's melting temperature. In addition, because iron has no solubility in tin around 220° C., the alloy will not coarsen easily when heated. The lack of solubility presents challenges regarding the adhesion of the iron particles to the solder alloy, which can be improved by eliminating the oxide layer that readily forms on small iron powders to help the tin-silver solder to adhere to the iron.

For tensile testing, several solder beads were reflowing and poured into an aluminum mold lined with graphite powder, which produced a void-filled specimen that was then diluted with an amount of bulk Sn—Ag ingot to yield the desired dispersion concentrations. Sn—Ag control samples were processed similarly. Tensile testing was conduct in accordance with ASTM E8M-04.

All tensile testing was done at room temperature and at strain rates of 0.002, 0.0002, and 10⁻⁶/s. Specimens were testing having concentrations of no Fe, 10% Fe, and 20% Fe powder (325 mesh) in a Sn—Ag matrix. Specimens were also tested with concentrations of 2.5% and 5% of 1-3 micron iron powder in a Sn—Ag matrix. To explore the impact on tensile strength of applying magnetic field during cooling, a specimen with 2.5% 325 mesh (sizes of 44 micron or less) iron was tested, reflowed in a magnetic field, and retested.

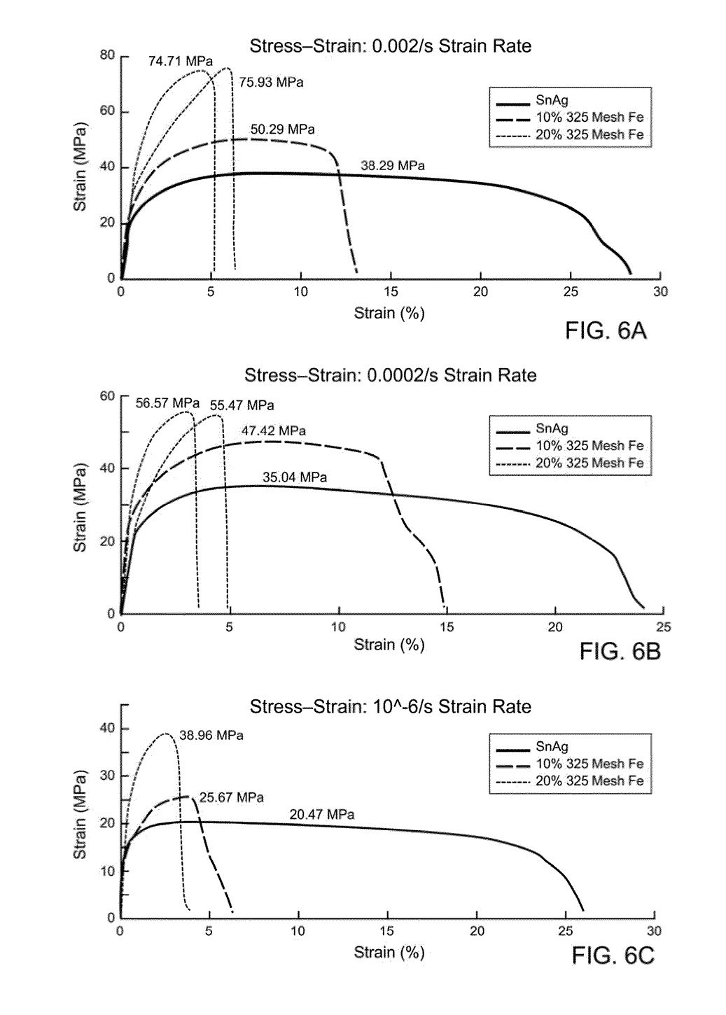

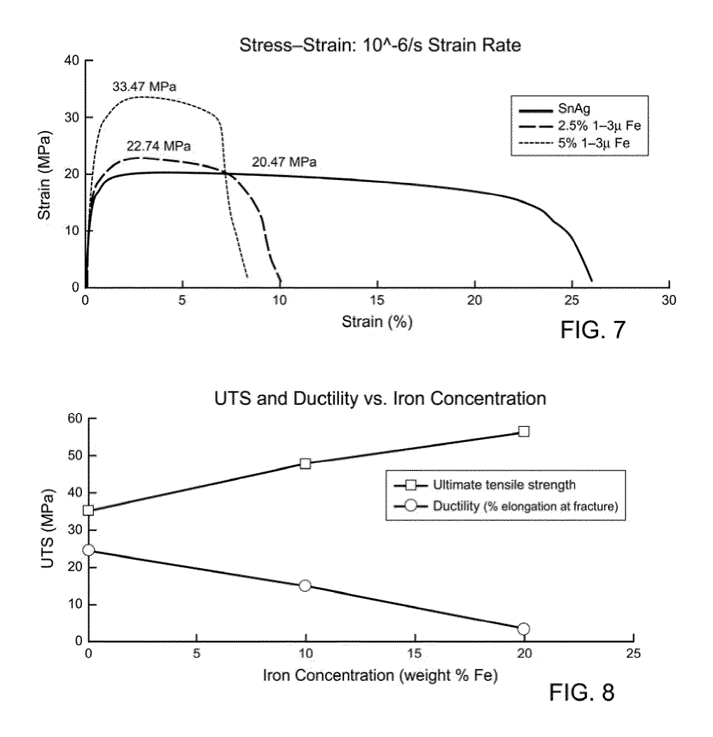

As shown in FIGS. 6a, 6b, and 6c, the Sn—Ag solder alloys having dispersed iron powder showed significant increases in ultimate tensile strength. At both the highest and lowest strain rates, the 20% 325 mesh iron samples were approximately twice as stronger as the iron-free Sn—Ag solder. However, the increase in strength comes at the price of ductility. In particular, a fivefold decrease in ductility was seen in the 20% iron samples, such that a Sn—Ag with 20% iron particles is a hard, strong, and brittle material. As shown in FIG. 7, dispersion of the smaller 1-3 micron iron particles yields qualitatively similar results at lesser concentrations of 2.5% Fe and 5% Fe by weight.

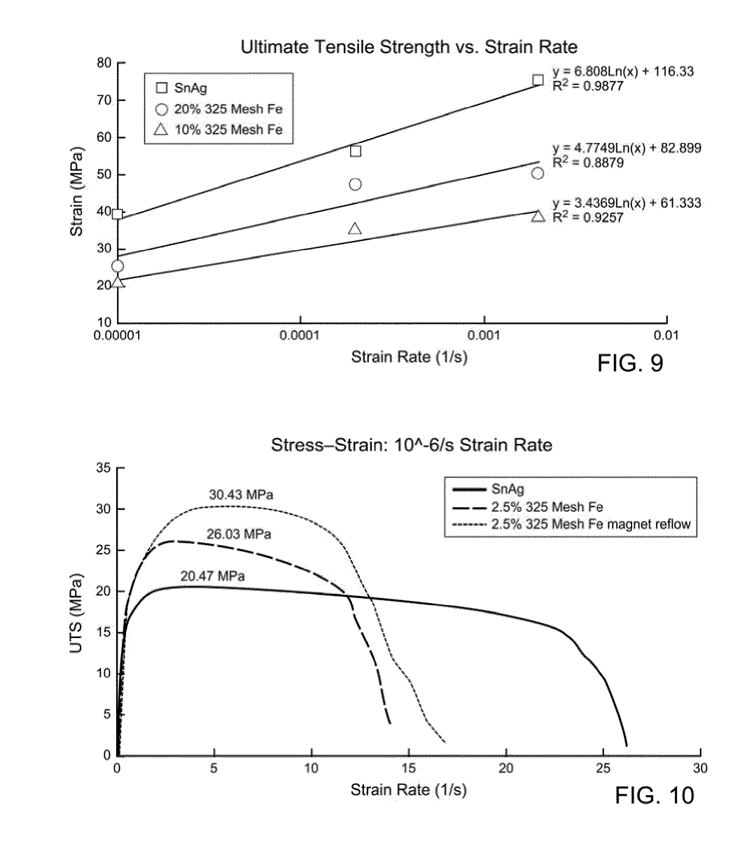

FIG. 8 shows that ductility has an inverse relationship to iron particle concentration while ultimate tensile strength has a direct relationship at the 0.0002/s strain rate, at least below 20% Fe by weight. Also, the elastic modulus of the solder alloy increases by 50% with 10% iron particles, suggesting that the composite is stiffer and more resistant to elastic deformation. The effect of strain rate on the tensile strength is plotted in FIG. 9, which shows that solder alloys with higher concentrations of iron are more sensitive to strain rate.

The tensile strength of Sn—Ag with dispersed Fe solder alloys can be improved by reflowing the solder alloys in a magnetic field. As shown in FIG. 10, Sn—Ag solder containing 2.5% iron powder, when reflowed in a magnetic field, showed an ultimate tensile strength increase of about 50% with much more plastic deformation before fracture than was seen with higher iron concentrations. Because a measure of toughness is the area under the stress-strain curve, both ultimate tensile strength and elongation are important for producing joints that can withstand real world applications. Therefore, reflow in a magnetic field, particularly with low iron concentrations, may be used to increase the toughness of Sn—Ag with dispersed Fe solder alloys.

Relatively uniform distribution of iron particles was obtained in a composite material containing 5% by weight of 325 mesh Fe, as verified by viewing a sample under a scanning electron microscope. Similarly, in a composite material containing 2.5% by weight of 1-3 micron particles of Fe, the particles were adequately wetted by the solder alloy, although some agglomeration was observed. However, some of the agglomeration may have been due to the reflowing and cooling of the composite material specimen with a single ceramic magnet held over the gage section, which may have drawn the magnetic particles upward together. In some samples of 20% by weight of 325 mesh Fe, small voids were clearly visible in solder alloy matrix. Assuming the voids are from oxidation/reduction reactions and not poor wetting of iron particles, reflowing in a vacuum should eliminate them and further improve mechanical properties.

Applications for low melting temperature magnetically-responsive composite materials.

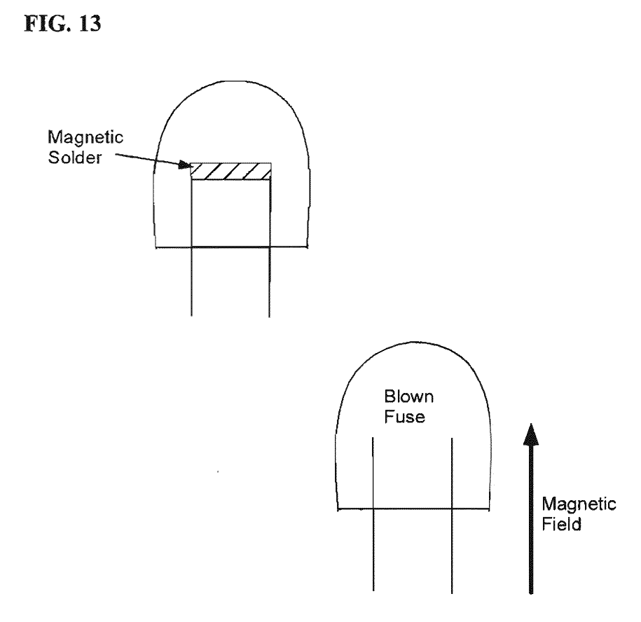

A wide variety of devices can be made from low melting temperature metal alloys that can be magnetically manipulated. In one example, as illustrated in FIG. 13, a magnetic fuse was made using a composite material as disclosed herein. The fuse, basically a magnetic-sensor circuit, creates an open circuit when magnetic fields are encountered. A circuit with a “fuse” segment of magnetically-responsive composite solder material can prevent the operation of equipment in high magnetic fields. When a suitable magnetic field is applied, the segment of the magnetic solder material will detach from the circuit creating an open circuit and preventing signal from flowing. This prevents damage to the instrument which may be sensitive to magnetic fields.

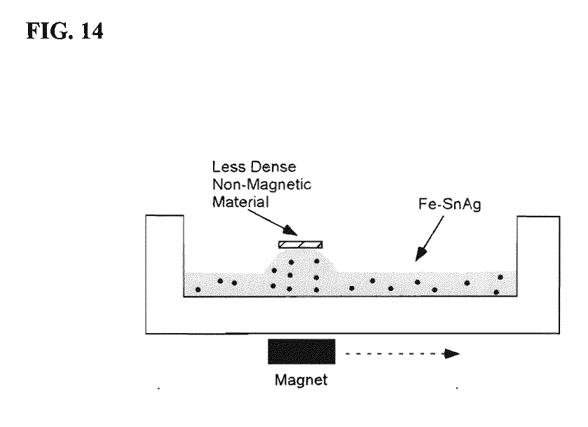

In another example, as illustrated in FIG. 14, molten beads of composite material including metal alloy and magnetic particles have used to conveyance less-dense objects (e.g., a copper coin) by applying a lateral magnetic force to magnetically manipulate the molten alloy. Applying a magnetic field aligns the dispersions within the molten composite material, causing the bead of molten composite material to “roll” across a surface, thereby laterally transporting an object disposed on top of the molten composite material. In essence, a small wave of molten solder can be created by a magnetic field and used to move buoyant pieces horizontally.

In other examples, the composite material can perform as a formable magnetorheological fluid that can be cast to many geometries caused by a magnetic field and then solidified, or can be used to create adaptive surfaces by making a wave in the solder under a flexible surface to adjust the morphology of a surface in a controllable way.

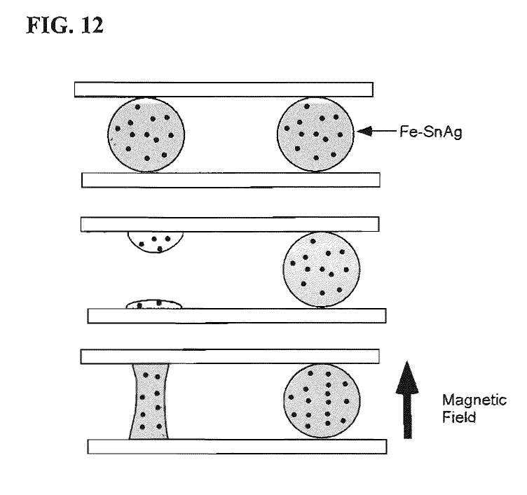

It is envisioned that magnetically-responsive alloys could be used for self-healing electronics assemblies, as shown in FIG. 12, in which defective or broken solder joints (i.e., those that cause open circuits) could be “healed” by heating the magnetically responsive solder in a magnetic field and allowing or magnetically manipulating the molten metal to restore a broken joint, thereby eliminating the need to remove and resolder components.

In the field of electronics packaging, vertical paths or vias, and other high-aspect ratio geometries, can be easily filled using magnetically-responsive alloys since application of a magnetic force above the alloy can overcoming the high surface energy (contact angle) of the alloy. Additionally, the presence of dispersed particles that are not alloyed improves the service performance of the composite material by increasing the mechanical strength and creep resistance of the material. The mechanical, electrical, and or thermal properties of the composite material can be tailored by controlling the amount, size, and distribution of magnetic particles in an alloy matrix. Mechanical properties can be further controlled by applying a unidirectional magnetic field during cooling of the alloy, to obtain directional dependence of properties (anisotropy). These properties can even be tailorable in localized regions of a structure (i.e., not uniformly throughout an entire piece of composite material) or monolithically.

Metallic structures can be fabricated from composite materials in fewer fabrication steps than was previously required. In particular, an alloy containing a dispersion of magnetic particles can be placed into a mold under a magnetic field to create three-dimensional conductive paths.

The composite materials disclosed herein can be put to several immediately valuable commercial uses.

One such use is drawing solder vertically and horizontally. Magnetically-responsive composite solder materials can be drawn into hard to reach areas, such as channels, through silicon vias (TSV), tubes, fittings, couplings, and hidden vias, using a magnetic field. These solders materials can be guided to regions that cannot be attained solely by capillarity, gravity, or direct manipulation. These materials would be particularly useful in multi-die packaging, whereby they can fill of through silicon vias (TSV) to connect stacked chips together to create 3D integrated circuits. Additionally, the composite solder materials can be drawn with containment to create structures of prescribed geometries; or without sidewalls to create irregular yet periodic shapes.

Another such use is shape and flow manipulation. The magnetically-responsive composite solder materials can be moved laterally as well as vertically. In their molten form, the horizontal spread of the composite materials can be modified with sufficient magnetic field to increase or decrease their coverage. This would be useful with solder bump shapes, fillet structures, and edges.

A further such use is in packaging. The composite materials can be used to seal packages. Like conventional solders, they can be heated (thermally or with a laser) to seal and create bonds. Thermal excursions needed for packaging or printed circuit boards (PCB) can be minimized by heating these magnetic solders with electromagnetic induction heating, which helps localize heat to seal, mount chips, and attach flip-chip assemblies. Additionally, the heating can occur generally or selectively. Multi-die packages, whereby multiple layers are stacked on top of each other, would benefit from this technology. Individual stacked layers can be separately addressed by selecting induction-heating conditions (of frequency and/or coil design) and by the solder formulations (of dispersion concentration, magnetic composition, and particle size). Foil, pre-forms, solder bumps, paste, slurry, and thin film embodiments are some possible forms for the composite materials disclosed herein.

Another such use is in self-healing joints as in FIG. 12. The composite materials can be used to create self-healing joints, in which contacts are re-established with suitable heating and magnetic field. These joints can serve as electrical contacts or as structural mechanical parts.

A further such use is in localized strengthening. The alignment of the magnetic particles within the solder matrix to create particle-rich and particle-depleted regions has been found to increase the overall strength. To create an aligned particle arrangement, suitable heat and magnetic field are needed. Heating of the solder can occur by thermal, laser, and induction heating methods. Alignment occurs when a magnetic field is applied (created by an electromagnet or a fixed magnet). Alignment of the particle can occur throughout the solder for an overall improved strength. Alternatively, alignment can occur to a local region of the solder for a localize strength increase. Alignment provides for mechanical properties of a composite solder material that can be tailored and modified without the need to add additional materials. These changes can remain permanently or can be modified (with the reapplication of heat and a different degree of magnetic field).

Another such use is in assisted wave soldering. In large scale “wave” soldering processes, components are attached to a printed circuit board by passing the board over a molten pool of solder. The solder wets the exposed metal surfaces and wicks upward. Printed circuit boards (PCBs) are used to hold the components of many electronic appliances. The components are bonded to PCBs by being inserted into prescribed holes and then adhered to the PCB by wave soldering. Wave soldering is a process whereby a PCB skims the top of a molten solder pool and the solder wicks up the prescribed holes that connect the components. This method employs capillary forces of solder to move vertically, but the drilled holes often require surface treatments or copper plating to insure the solder will wick. However, as PCB have evolved, they have become thicker and the wicking behavior of solder is not enough to enable solder to reach the top surface of the PCB. Thus, the wicking process must be assisted. One mechanism to increase the vertical excursions of solder is to use a magnetic composite solder material as described herein, so that the vertical movement can be assisted by applying a magnetic field while wave soldering. By hovering a magnet or magnetic field about the holes in the PCB, the solder will climb upwards and overcome the limitations that pure solder without magnetic dispersions cannot achieve. Using this magnetically assisted mechanism, wave soldering can be applied to through-hole assemblies and surface mounts where surfaces needing solder may not be in direct contact with the molten solder pool by enabling solder to be drawn through these channels and cavities beyond the limit of conventional solder's wetting and capillary abilities.

A further such use is in pick-and-place assembly. In surface mount technologies, a manual or robotic arm can precisely pick-and-place the magnetic composite solder materials to specific locations with the use of an electromagnet. This method can be applied to the magnetically-responsive solders as well as components containing them. Although the specific use would be for the electrical components, such as capacitors, resistors, and ICs onto a printed circuit board, it can also be applied to consumer goods, medical, automotive, and aerospace products.

Another such use is in desoldering. The removal of solder from a surface can be improved with the use of magnetic composite solder materials, by applying a magnetic field to lift the solder away from its location. If the solder is loose, a magnetic field can easily remove it. If the solder is attached, the solder can be collected with an applied magnetic field coupled with heat (such as from a heat gun, soldering iron, or laser). Alternatively, magnetic induction could be used to heat the solder and an electromagnetic assembly used to remove the solder, provided no magnetic fields interfere. This method increases the cleanliness and is an improvement over current methods which employ capillarity action (solder wicking) and vacuum (desoldering pumps), because it is specifically targeted to the solder and can achieve the removal of solder materials without the need for direct contact with the surface.

A further such use is in confined rework heating. In surface mount technologies, a large-scale process for repair of a broken joint is often not possible. Broken joints need to be repaired individually using hot-air guns or soldering irons. Localized heat is difficult with conventional non-magnetic solders. But heating magnetic solders with a small induction-heating coil will limit the areas that are exposed to high temperatures. These methods can also be used to create localized solder reflow.

The composite materials disclosed herein also have applications that are expected to commercially viable in the future.

One such application is in magnetolithography (ML), whereby a “magnetic mask” (commonly a paramagnetic material) defines the shape and spatial distribution of the features to be created with a magnetic field. A magnetic composite solder material would be applied to a surface of a substrate and would assemble itself onto the substrate according to the field of the magnetic mask to form a desired shape. The solder material would remain fixed in place as it solidifies. Sacrificial layers can be used to improve positioning of the composite solder materials, and to enable subsequent layers to be patterned on top of existing layers. The composite material can be used to create the negative or the positive of the image. After the image is created, the composite material can be removed. Such a method has the advantage of producing features with high precision and accuracy. It also provides a means to create multilayers with a high degree of alignment.

Another such application is as a sensor tag. Because the composite materials include magnetic particles incorporated in solder, the composite materials can be identified with suitable magnetic interrogation so as to serve as a passive tag. Such tags can help indentify and locate counterfeit parts and components. The tags can be indentified using magnetic field sensitive antennae similar to those found in various radio frequency identification (RFID) technologies.

A further such application is in conveyance, for example as shown in FIG. 14. It has been demonstrated that a pool of magnetically-responsive composite solder material can be moved laterally with an applied magnetic field. When a less-dense object is place on top of the solder, a magnetic field below the solder will cause the magnetic particles to align and lift upward. When the field is moved sideways, it moves the solder and in turn the object floating on top of it. Such a form of conveyance can be applied to manufacturing to move parts. These methods can also be applied to wave soldering to create localized waves to guarantee contact between the solder and the parts to be wetted by the solder.

A further such application is in formation of periodic structures. Magnetic composite materials can be used to quickly create a periodic array of structures by aligning the magnetic particles within the solder matrix by application of a magnetic field. The periodicity can be tailored by the magnetic field that is applied. Periodic structures can be used as meta-materials to make plasmonics or optical devices. When couple with lithographic techniques, the methods can be used to create diffraction gratings.

Another such application is as a latchable medium. An actuator or gear assembly can operate within a magnetic composite material when an external induction coil heats the solder. Then, when the heat is removed, the material freezes in place and the actuator maintains position without consuming any power.

A further such application is in self-assembled solder templates. The use of magnetically responsive composite solder materials ensures the registry of components to their contact pads. Joint locations can be templated with a magnetic layer or an applied magnetic field arrangement. A component containing magnetic solder will be readily lined up in the proper place and orientation with suitable magnetic field and mobility. For example, randomly assembled objects placed in a viscous medium, which provides suitable degrees of motion and rotation, will assemble themselves under a magnetic field according to the template structure.

Another such application is as glue joints for loose ends. In some cases, joints are needed between two non-fixed objects. For example, the fusion of nanowires is particularly challenging. Applying magnetic composite solder materials to the ends enables the ends to meet and attach when exposed to a suitable magnetic field. These solder materials can be attached via chemical or physical vapor methods, electroless or electrodeposition, lithography, or nano-manipulation. In a suitable medium, particles can be free floating. With the application of a magnetic field, they will align and can be bonded when heat is applied.

A further such application is as a viscosity switch. In its molten form, the composite solder material has a certain viscosity, depending on the base solder material and the type, size, shape, and concentration of magnetic particles. When a magnetic field is applied the viscosity increases due to the aligning of the magnetic particles. Such a mechanism could be use to increase or decrease the solder flow.

Another such application is stirring. Within wave soldering, induction currents cause currents of solder to flow and mix. Molten magnetic composite solder materials can also be used with immiscible liquids to stir them at high temperatures.

New composite solder materials and compositions are disclosed with improved mechanical properties, the ability to be guided with magnetic fields, and the ability to be heated via electromagnetic induction. A preferred embodiment is a metal matrix of a low melting point element or alloy (in bulk, paste, slurry, or thin film form), which contains magnetic particles (or dispersions) in it. By including magnetic particles into a solder matrix, the materials exhibit improved strength. By casting the solders in a magnetic field, the particles organize (aligned) and further increase the strength. Such a method allows materials to be selectively tailored in microstructure and strength. These new solder compositions have the ability to be manipulated and moved remotely via a magnetic field. Moreover, the addition of magnetic particles enables the solder materials to heat more rapidly in electromagnetic induction heating environments. This allows the solder materials to be selectively heated at a higher rate than conventional solders.

In sum, low melting temperature composite materials as disclosed have several advantages over metal alloys that do not include magnetic particle dispersions. The mechanical properties of composite materials can be tailored based on the concentration, distribution, and alignment of the magnetic particles to yield improved strength and creep-resistance over conventional lead-free solders. Additionally, the composite materials can be manipulated remotely by application of a magnetic field, which can even be used to overcome the surface energy of the solder alloy to draw the solder into vertical vias and other hard-to-reach places. When the composite materials are unconstrained, the application of a magnetic field above a free surface of the material can permanently cast the material into a spiked shape. Further, because the embedded magnetic particles make the solder alloy particular susceptible to induction heating, the solder alloy can be melted without exposing surrounding components to high temperatures, and solder joints can be made to self-heal. Also, the presence of particle dispersions increases creep resistance and toughness of the composite materials as compared with solder alloys not having dispersions.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

What is claimed is:

1. A low melting temperature composite material comprising:
an alloy comprising:
about 0.1% by weight to about 99% by weight of tin; and
about 0.1% by weight to about 90% by weight of an element selected from the group consisting of silver and gold; and
about 0.1% by weight to about 50% by weight of magnetic particles dispersed in the alloy.

2. The composite material of claim 1, comprising:
about 75% by weight to about 97% by weight of tin;
about 1% by weight to about 5% by weight of silver;
about 0.5% by weight to about 20% by weight of magnetic particles.

3. The composite material of claim 2, comprising:
about 84.5% by weight to about 97% by weight of tin;
about 2% by weight to about 3.5% by weight of silver, and
about 1% by weight to about 10% by weight of magnetic particles.

4. The composite material of claims 11, further comprising about 0.1% by weight to about 5% by weight of copper.

5. The composite material of claim 1, wherein the magnetic particles include one or more of ferromagnetic, ferromagnetic, and paramagnetic materials.

6. The composite material of claims 1, wherein the magnetic particles include ferromagnetic oxides selected from the group consisting of Fe₃O₄, MNFe₂O₄, NiFe₂O₄, MgFe₂O₄, Fe₇S₈, Fe₃S₄, g-FeOOH, Yttrium iron garnet (YIG), and any combination of these materials and their alloys.

7. The composite material of claims 1, wherein the magnetic particles include ferromagnetic materials selected from the group consisting of Co, Fe, Ni, Gd, Dy, EuO, Fe₃O₄, NiOFe₂O_{3′} MgOFe₂O₃, MnBi, MnO, Fe₂O₃, Y₃Fe₅O₁₂, CrO₂, MnAs, MnB, Mn₄N, MnSb, CrTe, CoO, NiO, CuO, BaCO₃, SrCO₃, MnZn, SmCo, AlNiCo, MnO, FeO, UH₃, Heusler Alloys (Cu₂MnAl, Cu₂MnIn), NdFeB, Permalloy (nickel-iron alloys), Supermalloys (79% Ni, 5% Mn, 16% Fe), magnetic stainless steel alloys (304 and 316), and any combination of these materials and their alloys.

8. The composite material of claims 1, wherein the magnetic particles include paramagnetic materials selected from the group consisting of Na, Al, salts of transition metals, salts and oxides of rare earth, rare earth elements, many metals, and any combination of these materials and their alloys.

9. The composite material of claims 1, wherein the magnetic particles include one or more of elemental metal, mixtures of elemental metals, oxides, nitrides, carbides, borides and fluorides, iron, cobalt, nickel, and any combination of these materials and their alloys.

10. The composite material of claims 1, wherein the magnetic particles are clustered into particle-rich and particle-depleted zones by application of a unidirectional magnetic field.

11. The composite material of claims 1, wherein the magnetic particles are one or more of spherical, elongated, plate-like, rod-like, nanowires, or randomly shaped.

12. The composite material of claims 1, wherein the magnetic particles are one or more of particles, intermetallics, separate phases, solute atoms, nanoparticles, and precipitates.

13. The composite material of claims 1, wherein the magnetic particles have a size from about 1 nm to about 500 microns.

14. The composite material of claim 13, wherein the magnetic particles have a size from about 100 nm to about 100 microns.

15. The composite material of claim 14, wherein the magnetic particles have a size from about 1 micron to about 50 microns.

16. A method of heating a low melting temperature composite material comprising an alloy of about 75% by weight to about 97% by weight of tin and about 1% by weight to about 5% by weight of silver, and about 0.5% by weight to about 20% by weight of magnetic particles, the method comprising: exposing the composite material to an alternating magnetic field.

17. The method of claim 16, wherein the magnetic field is alternated at a frequency of about 5 Hz to about 50 kHz.

18. A method of manipulating a low melting temperature composite material comprising an alloy of about 75% by weight to about 97% by weight of tin and about 1% by weight to about 5% by weight of silver, and about 0.5% by weight to about 20% by weight of magnetic particles, the method comprising:
heating the composite material to a melting temperature; and
applying a magnetic field to attract or repel the molten composite material.

19. The method of claim 18, wherein heating is accomplished by exposing the composite material to an alternating magnetic field.

20. The method of claim 18, further comprising:
causing the molten composite material to move in a vertical upward direction by applying an attractive magnetic force above the composite material.

21. The method of claim 18, further comprising:
causing the molten composite material to act as a conveyance for an lower specific-gravity object located on top of the composite material by applying an attractive or repulsive magnetic force laterally with respect to the composite material.

22. A method of enhancing the mechanical properties of a low melting temperature composite material comprising an alloy of about 75% by weight to about 97% by weight of tin and about 1% by weight to about 5% by weight of silver, and about 0.5% by weight to about 20% by weight of magnetic particles, the method comprising: applying a unidirectional magnetic field to alloy while the alloy is cooled from a molten state to a solid state.

23. A method of making a low melting temperature composite material, comprising:
grinding together a mixture of iron powder with Sn—Ag solder powder;
adding flux to the powder mixture to form a paste; and
heating the paste to boil off the flux and melt the paste.
